(19) United States
(12) Patent Application Publication
(10) Pub. No.: US 2018/0017448 A1
(43) Pub. Date: Jan. 18, 2018

(54) DEVICE FOR A HOUSEHOLD APPLIANCE FOR DETERMINING A TRANSPORT CONDITION OF THE HOUSEHOLD APPLIANCE, HOUSEHOLD APPLIANCE, AND METHOD FOR DETERMINING A TRANSPORT CONDITION OF A HOUSEHOLD APPLIANCE

(71) Applicant: Miele & Cie. KG, Guetersloh (DE)

(72) Inventors: Tobias Heidemann, Melle (DE); Detlef Niehaus, Hamm (DE)

(21) Appl. No.: 15/646,108

(22) Filed: Jul. 11, 2017

(30) Foreign Application Priority Data
Jul. 12, 2016 (DE) 10 2016 112 705.1

(51) Int. Cl. G01K 13/00; G06Q 10/10; G06Q 10/08

(52) U.S. Cl. CPC G01K 13/00; G06Q 10/083; G06Q 10/10

(57) ABSTRACT

A device for a household appliance for determining a transport condition of the household appliance includes a data processing unit that stores and/or evaluates a measurement value from a sensor associated or associatable with the household appliance in order to determine the transport condition; and an energy storage device electrically conductively coupled or couplable to the data processing unit to supply the data processing unit with electrical energy while the household appliance is off.

### CROSS-REFERENCE TO PRIOR APPLICATION

Priority is claimed to German Patent Application No. DE 10 2016 112 705.1, filed on Jul. 12, 2016, the entire disclosure of which is hereby incorporated by reference herein.

### FIELD

The present invention relates to a device for a household appliance for determining a transport condition of the household appliance, a household appliance, and a method for determining a transport condition of a household appliance.

### BACKGROUND

Today's household appliances have sensors installed therein which are used to monitor and control the appliance processes during the operation of the appliance.

### SUMMARY

In an embodiment, the present invention provides a device for a household appliance for determining a transport condition of the household appliance, the device comprising: a data processing unit configured to store and/or evaluate a measurement value from a sensor associated or associatable with the household appliance in order to determine the transport condition; and an energy storage device electrically conductively coupled or couplable to the data processing unit to supply the data processing unit with electrical energy while the household appliance is off.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a household appliance having a device for determining a transport condition of the household appliance in accordance with an exemplary embodiment;

FIG. 2 is a block diagram of a device for determining a transport condition of a household appliance in accordance with an exemplary embodiment;

FIG. 3 is a block diagram of a control system for determining a transport condition of a household appliance in accordance with an exemplary embodiment;

FIG. 4 is a flow chart of a method for determining a transport condition of a household appliance in accordance with an exemplary embodiment.

### DETAILED DESCRIPTION

In an embodiment, the present invention provides an improved device for a household appliance for determining a transport condition of a household appliance, an improved household appliance, and an improved method for determining a transport condition of a household appliance. Advantageous embodiments and refinements of the present invention will become apparent from the following dependent claims.

Supplying electrical energy from an energy storage device provided in a household appliance to a data processing unit associated with the household appliance enables a measurement value from a sensor associated or associatable with the household appliance to be stored and/or evaluated while the appliance is off in order to determine at least one transport condition for the appliance during transport thereof.

The here presented concept of alternative connection of sensors in household appliances in conjunction with an additional data processing unit or evaluation unit enables determining and/or recording of potentially detrimental transport conditions of appliances without adding complexity to the appliance construction or separately powered determining units added to the appliance or to the packaging.

A thereby possible large number of feedbacks from the appliances and, for example, the transportation route thereof allows the appliances to be optimized better with respect to the conditions expected during use as well as during transport.

A device for a household appliance for determining a transport condition of the household appliance has the following features:

a data processing unit adapted to store and/or evaluate a measurement value from a sensor associated or associatable with the household appliance in order to determine the transport condition; and

an energy storage device electrically conductively coupled or couplable to the data processing unit to supply the data processing unit with electrical energy while the household appliance is off.

The household appliance may be an electrically operated appliance which may be used, for example, in private households such as, for example, a washing machine, a dryer or a range. A transport condition may be understood to be a typical possible influence on the household appliance during its transport, for example, from the wholesaler to the retailer or from the retailer to the customer. Transport conditions include, for example, the temperature in the delivery vehicle, impacts on the appliance en route, the loaded position of the appliance in the transport vehicle, etc.

In the present context, the device may be understood to be an electrical device that processes sensor signals and outputs control and/or data signals as a function thereof. The device may have an interface which may be implemented in hardware and/or software. When implemented in hardware, the interfaces may, for example, be part of a so-called “system ASIC” which includes a wide variety of device functions. However, the interfaces may also be separate integrated circuits or may be at least partly composed of discrete components. When implemented in software, the interfaces may be software modules that are present, for example, on a microcontroller in addition to other software modules.

The measurement value may be present or provided, for example, in the form of an electrical signal. The sensor may be an active or passive sensing element, which may be suitable to be installed on the housing or inside the household appliance. The data processing unit may be adapted to process data and information contained in the measurement value with respect to the transport condition, using suitable algorithms. The energy storage device may be coupled or couplable to the data processing unit, for example, via electrical leads.

In accordance with an embodiment, the energy storage device may be in the form of an electrochemical energy storage device, such as, for example, a battery, and/or an electrical energy storage device, such as, for example, a capacitor. Thus, the energy storage device can be used as a variable component in a cost-effective manner.

In particular, the energy storage device may be electrically conductively coupled or couplable to a clock integrated or integratable into the household appliance. Thus, an energy storage device used, for example, for a real-time clock of the appliance may advantageously be used for the additional function of supplying electrical energy to the device. Thus, no additional component is needed.

Furthermore, the clock may be integrated or integratable into the data processing unit. This embodiment makes it possible to save space and to dispense with additional electrical leads.

It is also advantageous for the device to have a read-in device. The read-in device may be adapted to read the measurement value via an interface with the sensor. This allows the measurement value to be provided to the data processing unit in a quick and optimal fashion, for example, in a time-controlled manner.

The device may also include a data store for storing the measurement value and/or the transport condition. This advantageously allows the measurement value and the transport condition to be held available for a later time, such as when the household appliance is initially placed into operation.

The data store may include, for example, at least one non-volatile memory cell and/or flash cell. This embodiment allows the data store to be accessed in various ways, such as, for example, by field service personnel or employees of the manufacturer.

Moreover, the device may include an output device for providing the measurement value and/or the transport condition to a processing unit or an output unit of the household appliance. This embodiment advantageously allows the transport condition data and, possibly, the underlying measurement values to be read out, for example, during a field service visit or if the household appliance is networked with the manufacturer.

In accordance with another embodiment, the device may include at least one sensor. The sensor may be electrically conductively connected or connectable to the data processing unit. The sensor can enable determining of one or more transport conditions in an optimal manner.

The sensor may take the form of, for example, a temperature sensor and/or an acceleration sensor. This embodiment makes it possible to obtain important information about the effects that different temperature ranges during storage and/or transport of the household appliance have on the later functioning of the household appliance.

A household appliance has the following features:

a device according to one of the embodiments described above; and

a sensor which is electrically conductively connected or connectable to the device.

A method for determining a transport condition of a household appliance includes the following step:

evaluating and/or storing a measurement value from a sensor associated or associatable with the household appliance by means of a data processing unit in order to determine the transport condition, using an energy storage device which is electrically conductively coupled or couplable to the data processing unit to supply the data processing unit with electrical energy while the household appliance is off.

This method may be implemented, for example, in software or hardware, or as a software and hardware hybrid, for example, in a device or a controller.

The object underlying the present invention can also be achieved rapidly and efficiently through this embodiment variant of the present invention in the form of a method.

Also advantageous is a computer program product or computer program having program code, which may be stored on a machine-readable carrier or storage medium, such as a semiconductor memory, a hard-disk memory or an optical memory, and is used to carry out, implement and/or control the steps of the method in accordance with one of the aforedescribed embodiments, particularly when the program product or program is executed on a computer or a device.

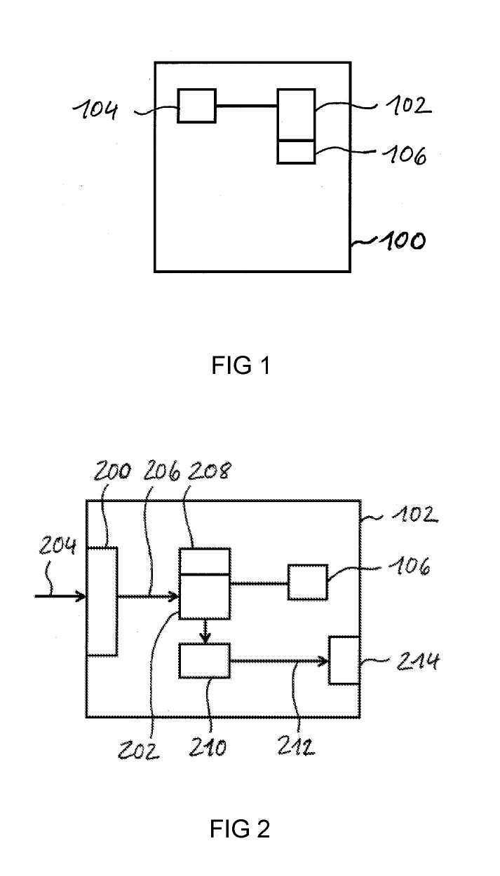

FIG. 1 schematically shows a household appliance 100 having a device 102 for determining a transport condition of household appliance 100 in accordance with an exemplary embodiment. Household appliance 100 is an electrically operated appliance used in the household, such as a washing machine, a laundry dryer, a dishwasher, or a range or oven. Household appliance 100 is equipped with at least one sensor 104, here a temperature sensor 104. In the operating state of household appliance 100, sensor 104 serves to monitor operating processes and may be provided as a standard in household appliance 100.

In accordance with the here presented concept of determining transport conditions of home appliances or household appliances using existing sensors of the appliances, sensor 104 is electrically conductively connected to device 102 via an energy storage device 106 of household appliance 100. Energy storage device 106 forms part of device 102 or is electrically conductively connected thereto, and its original function is to supply power to a real-time clock of household appliance 100.

In accordance with the approach proposed herein, energy storage device 106, which is originally used for buffering the clock of appliance 100 by means of the power supply, is additionally used for determining the condition of the appliance, for example during transport of appliance 100, via the existing sensor 104, and possibly additionally installed sensors. For instance, temperature sensor 104, for example, may record the thermal conditions, and an additionally installed acceleration sensor may record additional transport conditions of appliance 100. Sensor 104 may be active or passive. In the active version, sensor 104 is also supplied by energy storage device 106 with electrical or electrochemical energy, for example, via the real-time clock of appliance 100. Sensor 104 provides its measurement values, for example, in the form of an electrical signal, to device 102 at a predetermined sampling rate.

FIG. 2 shows a block diagram of an exemplary embodiment of a device 102 for determining a transport condition of a household appliance. The exemplary device 102 shown in FIG. 2 includes a read-in device 200, a data processing unit 202, and energy storage device 106.

Read-in device 200 is adapted to read a measurement value 204 via an interface with a sensor of a household appliance associated with device 102 and, in accordance with the exemplary embodiment shown in FIG. 2, to provide measurement or sensor data 206 representing measurement value 204 to data processing unit 202. Data processing unit 202 is configured to store and/or evaluate measurement value 204 or measurement value data 206 representing measurement value 204 in order to determine a transport condition of the household appliance. To this end, data processing unit 202 is supplied with electrical energy from energy storage device 106 of the household appliance, to which it is electrically conductively connected.

Data processing unit 202 is hereinafter also referred to as evaluation unit 202. In order to evaluate the obtained data 206 to determine a transport condition of the associated appliance, evaluation unit 202 uses, for example, suitable algorithms. Depending on the design of the appliance, energy storage device 106 may be an electrical or electrochemical energy storage device. In the electrical variant, energy storage device 106 is, for example, a capacitor. In the electrochemical variant, energy storage device 106 is, for example, a battery. Energy storage device 106 is electrically conductively coupled to evaluation unit 202 to supply it with electrical energy while the household appliance is off, such as, for example, during transport of the appliance.

In accordance with a preferred exemplary embodiment, shown in FIG. 2, energy storage device 106 is electrically conductively coupled to a clock 208 (e.g., a real-time clock 208) integrated into the household appliance. In the exemplary embodiment shown in FIG. 2, clock 208 is integrated into data processing unit 202.

In accordance with another exemplary embodiment, device 102 further includes a data store 210 adapted store a transport condition 212 determined by evaluation unit 202 and/or the measurement value 204 or measurement value data 206 underlying the transport condition 212. This allows transport condition 212 to be read from device 102 at a later time, such as when the household appliance is initially placed into operation. Data store 210 forms part of evaluation unit 202 or is electrically conductively connected thereto. In the variant of device 102 shown in FIG. 2, data store 210 has one or more non-volatile flash cells for storing the saved data.

For purposes of providing transport condition 212, for example, to a processing unit or output unit of the household appliance, the exemplary embodiment of device 102 shown in FIG. 2 has an output device 214 which is connected to data store 210 via a data line. Thus, transport condition 212 can be readily read from device 102, for example, during a field service visit or if the household appliance is networked with the manufacturer.

In accordance with an exemplary embodiment, device 102 includes the sensor or an additional sensor for acquiring additional measurement values for additional transport conditions. In accordance with an exemplary embodiment, the sensor or the additional sensor is electrically conductively connected to data processing unit 202.

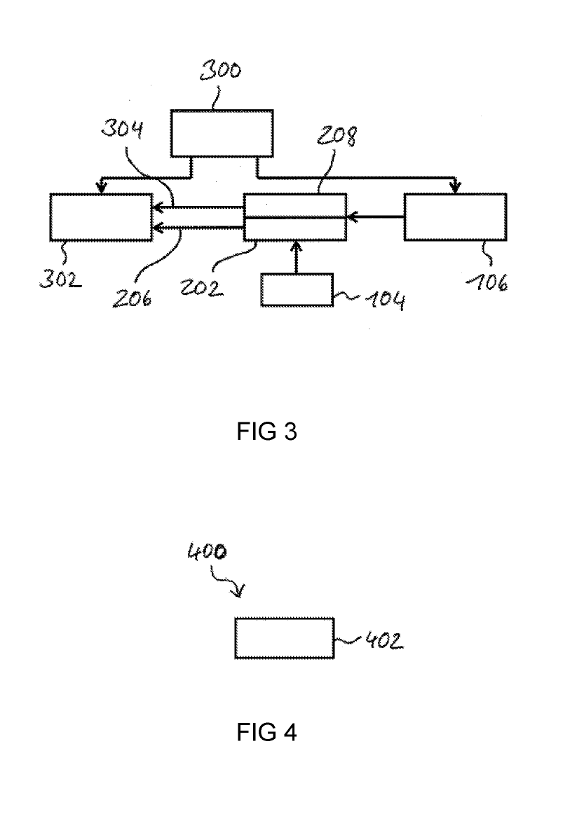

FIG. 3 shows a block diagram of a control system for determining a transport condition of a household appliance in accordance with an exemplary embodiment. A supply voltage 300 of the household appliance supplies electrical energy to energy storage device 106 and a processing unit 302, here a control processor 302. The charging of energy storage device 106 is performed when the appliance is powered from the line, such as, for example, during a test run prior to delivery of the appliance.

Evaluation unit 202 has an exemplary real-time clock 208, which is supplied with electrical energy from energy storage device 106, which takes the form of a special capacitor. The sensors 104 already present in the appliance are connected to evaluation unit 202, which is powered from energy storage device 106 of clock 208. Thus, the supply of energy from energy storage device 106 enables evaluation unit 202 to acquire and store the measurement values from sensors 104 and the transport condition of the appliance determined therefrom while the appliance is off.

The recorded transport conditions as well as the underlying sensor data 206 are transferred together with clock data 304 via a suitable interface to control processor 302 when the appliance is initially placed into operation after transport. If the household appliance is networked by the manufacturer, sensor data 206 can be retrieved and evaluated for purposes of improving the appliance. However, sensor data 206 can also be read out during a field service visit and used as described above.

FIG. 4 shows a flow chart of an exemplary embodiment of a method 400 for determining a transport condition of a household appliance. The method may be performed by the device shown in FIG. 1 in order to determine transport conditions of the household appliance shown in FIG. 1.

In an evaluating and/or storing step 402, a measurement value from a sensor associated or associatable with the household appliance is evaluated and/or stored in order to determine the transport condition. Evaluating and/or storing step 402 is performed in a data processing unit, using an energy storage device of the household appliance, the energy storage device being electrically conductively coupled or couplable to the data processing unit to supply the data processing unit with electrical energy while the household appliance is off.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A device for a household appliance for determining a transport condition of the household appliance, the device comprising:
a data processing unit configured to store and/or evaluate a measurement value from a sensor associated or associatable with the household appliance in order to determine the transport condition; and
an energy storage device electrically conductively coupled or couplable to the data processing unit to supply the data processing unit with electrical energy while the household appliance is off.

2. The device as recited in claim 1, wherein the energy storage device comprises an electrochemical energy storage device and/or an electrical energy storage device.

3. The device as recited in claim 1, wherein the energy storage device is electrically conductively coupled or couplable to a clock integrated or integratable into the household appliance.

4. The device as recited in claim 3, wherein the clock is integrated or integratable into the data processing unit.

5. The device as recited in claim 1, further comprising a read-in device configured to read the measurement value via an interface with the sensor.

6. The device as recited in claim 1, further comprising a data store configured to store the measurement value and/or the transport condition.

7. The device as recited in claim 6, wherein the data store includes at least one non-volatile memory cell.

8. The device as recited in claim 1, further comprising an output device configured to provide the measurement value and/or the transport condition to a processing unit or an output unit of the household appliance.

9. The device as recited in claim 1, further comprising a sensor electrically conductively connected or connectable to the data processing unit.

10. The device as recited in claim 9, wherein the sensor comprises a temperature sensor and/or an acceleration sensor.

11. A household appliance, comprising:
the device according to claim 1; and
a sensor electrically conductively connected or connectable to the data processing unit.

12. A method for determining a transport condition of a household appliance, the method comprising:
evaluating and/or storing a measurement value from a sensor associated or associatable with the household appliance using a data processing unit in order to determine the transport condition; and
using an energy storage device which is electrically conductively coupled or couplable to the data processing unit to supply the data processing unit with electrical energy while the household appliance is off.
